(19) United States
(12) Patent Application Publication
(10) Pub. No.: US 2009/0164206 A1
(43) Pub. Date: Jun. 25, 2009

(54) METHOD AND APPARATUS FOR TRAINING A TARGET LANGUAGE WORD INFLECTION MODEL BASED ON A BILINGUAL CORPUS, A TLWI METHOD AND APPARATUS, AND A TRANSLATION METHOD AND SYSTEM FOR TRANSLATING A SOURCE LANGUAGE TEXT INTO A TARGET LANGUAGE TRANSLATION

(75) Inventors: Liu ZHANYI, Beijing (CN); Wang HAIFENG, Beijing (CN); Wu HUA, Beijing (CN)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: KABUSHIKI KAISHA TOSHIBA

(21) Appl. No.: 12/328,476

(22) Filed: Dec. 4, 2008

(30) Foreign Application Priority Data
Dec. 7, 2007 (CN) 200710186545.6

(51) Int. Cl. G06F 17/28

(52) U.S. Cl. 704/2

(57) ABSTRACT

The present invention provides a method and apparatus for training a target language word inflection (TLWI) model based on a bilingual corpus, a TLWI method and apparatus, and a translation method and system for translating a source language text into a target language translation. In the method for training a TLWI model based on a bilingual corpus, the bilingual corpus includes a plurality of aligned corpus pairs of source language and target language, the method comprises building an initial TLWI model, pre-processing the source language corpus and the target language corpus, extracting patterns containing TLWI information, based on the pre-processed source language corpus and the target language corpus, and training the TLWI model by using the patterns.

### CROSS-REFERENCE TO RELATED APPLICATIONS

This application is based upon and claims the benefit of priority from prior Chinese Patent Application No. 200710186545. 6, filed Dec. 7, 2007, the entire contents of which are incorporated herein by reference.

### BACKGROUND OF THE INVENTION

1. Field of the Invention

The present invention relates to target language word inflection (TLWI) in the corpus based automatic machine translation technology, specifically, relates to a method and apparatus for training a target language word inflection (TLWI) model based on a bilingual corpus, a TLWI method and apparatus, and a translation method and system for translating a source language text into a target language translation.

2. Description of the Related Art

In many languages, there exists word inflection. For example, in English, verbs could be inflected in tense and nouns could be inflected in number. Thus information such as time, number and sensibility can be obtained from the word inflection and used to understand the English sentence accurately.

Currently, there exist two main techniques for the automatic machine translation: rule-based approach and corpus-based approach. The rule-based approach is to utilize translation rules to train and build a translation model and make translation based on the trained translation model. The corpus-based approach is to utilize a bilingual corpus to train and build the translation model.

In the rule-based approach, the target language word inflection can be produced by using the translation rules. But generally the translation rules are written manually, which would spend much time. And the translation rules must use deep syntax parsing information. For spoken language translation, the structure of the sentence is very relaxed, so it is very difficult to parse the sentence accurately.

In the corpus-based approach, the target language word inflection comes from the bilingual corpus. Only the bilingual corpus contains the target language word inflection, the translation model based on this bilingual corpus could output the target language word inflection. Therefore the size of the bilingual corpus will affect the accuracy of the translation.

The rule-based approach and the corpus-based approach have been described in detail, for example, in the book “Machine Translation Theory”, Tiejun ZHAO, etc. (Harbin Institute of Technology Press, May, 2001), and in the book “Machine Translation: an Introductory Guide”, D. J. Arnold, Lorna Balkan, Siety Meijer, R. Lee Humphreys and Louisa Sadler (Blackwells-NCC, 1994), and in the article “Machine Translation over Fifty Years”, John Hutchins, in Histoire, Epistemologies, Language, Tome XXII, pp. 7-31, 2001.

### BRIEF SUMMARY OF THE INVENTION

The present invention is directed to above technical problems and provides a method and apparatus for training a target language word inflection (TLWI) model based on a bilingual corpus, a TLWI method and apparatus, and a translation method and system for translating a source language text into a target language translation.

According to one aspect of the invention, there is provided with a method for training a target language word inflection model based on a bilingual corpus, wherein the bilingual corpus includes a plurality of aligned corpus pairs of source language and target language, the method comprising: building an initial TLWI model; pre-processing the source language corpus and the target language corpus; extracting patterns containing TLWI information, based on the pre-processed source language corpus and the target language corpus; and training the TLWI model by using the patterns.

According to another aspect of the invention, there is provided with a TLWI method, wherein a source language text is translated into a target language translation and the source language text is pre-processed so that each of source language words in the source language text is prototypical and tagged with POS, the method comprising: training a TLWI model by using the above method for training a target language word inflection model based on a bilingual corpus; and inflecting target language words in the target language translation based on the TLWI model.

According to another aspect of the invention, there is provided with a translation method for translating a source language text into a target language translation, comprising: pre-processing the source language text to obtain a sequence of source language words each of which is prototypical and tagged with POS; translating the pre-processed source language text into an initial target language translation based on a corpus based translation model; and editing the initial target language translation to obtain the final target language translation by using the above TLWI method.

According to another aspect of the invention, there is provided with an apparatus for training a TLWI model based on a bilingual corpus, wherein the bilingual corpus includes a plurality of aligned corpus pairs of source language and target language, the apparatus comprising: an initial model builder configured to build an initial TLWI model; a corpus pre-processing unit configured to pre-process the source language corpus and the target language corpus; a pattern extractor configured to extract patterns containing TLWI information based on the pre-processed source language corpus and the target language corpus; and a training unit configured to train the TLWI model by using the patterns.

According to another aspect of the invention, there is provided with a TLWI apparatus, wherein a source language text is translated into a target language translation and the source language text is pre-processed so that each of source language words in the source language text is prototypical and tagged with POS, the apparatus comprising: a TLWI model trained by the above apparatus for training a TLWI model based on a bilingual corpus; and a word inflection unit configured to inflect target language words in the target language translation based on the TLWI model.

According to another aspect of the invention, there is provided with a translation system for translating a source language text into a target language translation, comprising: a text pre-processing unit configured to pre-process the source language text to obtain a sequence of source language words each of which is prototypical and tagged with POS; a corpus based translation model configured to translate the pre-processed source language text into an initial target language translation based on; and a TLWI apparatus according to any one of claims 25-27 configured to edit the initial target language translation to obtain the final target language translation.

### BRIEF DESCRIPTION OF THE SEVERAL VIEWS OF THE DRAWING

FIG. 1 is a flow chart of a method for training a TLWI model based on a bilingual corpus according to one embodiment of the present invention.

FIG. 2 is a flow chart of the step of extracting patterns in the embodiment shown in FIG. 1.

FIG. 3 is a flow chart of a TLWI method according to one embodiment of the present invention.

FIG. 4 is a flow chart of the step of inflecting in the embodiment shown in FIG. 3.

FIG. 5 is a flow chart of a translation method for translating a source language text into a target language translation according to one embodiment of the present invention.

FIG. 6 is a schematic block diagram of an apparatus for training a TLWI model based on a bilingual corpus according to one embodiment of the present invention.

FIG. 7 is a schematic block diagram of the pattern extractor in the embodiment shown in FIG. 6.

FIG. 8 is a schematic block diagram of a TLWI apparatus according to one embodiment of the present invention.

FIG. 9 is a schematic block diagram of the word inflection unit in the embodiment shown in FIG. 8.

FIG. 10 is a schematic block diagram of a translation system for translating a source language text into a target language translation according to one embodiment of the present invention.

### DETAILED DESCRIPTION OF THE INVENTION

It is believed that the above and other objectives, characteristics and advantages of the present invention will be more apparent with the following detailed description of the specific embodiments for carrying out the present invention taken in conjunction with the drawings.

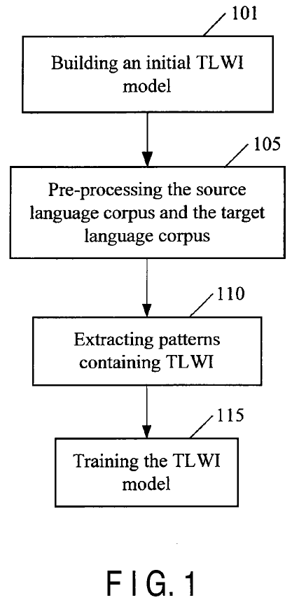

FIG. 1 is a flow chart of a method for training a TLWI model based on a bilingual corpus according to one embodiment of the present invention. This embodiment will be described in conjunction with the figure. The TLWI model which is trained by using the method of this embodiment will be used in a TLWI method and a translation method for translating a source language text into a target language translation which will be described later in other embodiments.

In this embodiment, the bilingual corpus includes a plurality of aligned corpus pairs of source language and target language and the corpus can be in phrase form, sentence form or paragraph form. In order to facilitate the description, in the present and later described embodiments, it is assumed that the corpus is in sentence form. That is, the bilingual corpus is the bilingual example corpus in which the source language sentences and the target language sentences are aligned.

As shown in FIG. 1, firstly at Step 101, an initial TLWI model is built. In this embodiment, the TLWI model can be a probability model, such as P (action|condition), or a pattern recognition model, for example, a SVM (Support Vector Machine) based pattern recognition model and a decision tree based pattern recognition model.

Then at Step 105, the source language sentences and the target language sentences in the bilingual example corpus are pre-processed. Specifically, for each pair of the plurality of aligned sentence pairs of source language and target language, the source language sentence is pre-processed so that each of source language words in the pre-processed source language sentence is prototypical and tagged with Part of Speech (POS). At the same time, the target language sentence is pre-processed so that each of target language words in the pre-processed target language sentence is prototypical and tagged with POS.

Next the step 105 will be described assuming the source language is Chinese and the target language is English. Firstly, the Chinese sentence is segmented into a sequence of Chinese words each of which is tagged with POS. The segmentation method is known to the person skilled in the art and its description will be omitted. Then, each of the English words in the English sentence is stemmed and tagged with POS.

At Step 110, based on the pre-processed plurality of aligned sentence pairs of source language and target language, patterns containing TLWI information can be extracted.

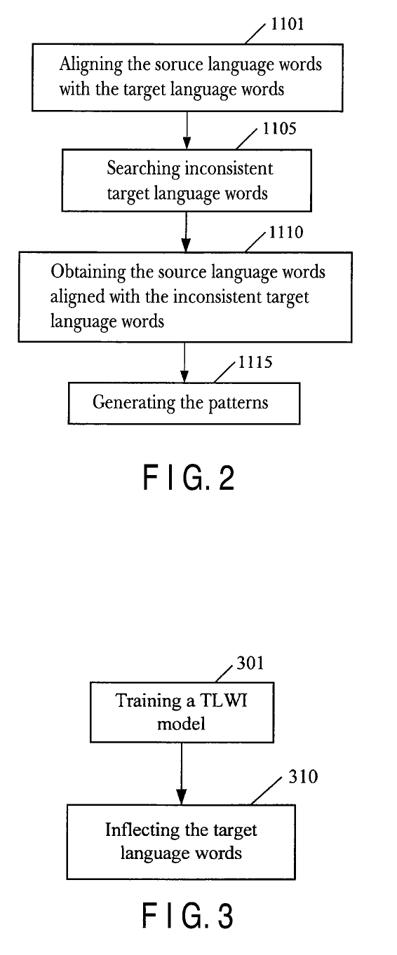

FIG. 2 shows a flow chart of the step 110 of extracting patterns. As shown in FIG. 2, firstly at Step 1101, the source language words in the pre-processed source language sentence are aligned with the target language words in the pre-processed target language sentence to obtain word alignment information. In this step, any existing or future alignment method can be used to perform the word alignment.

Then at Step 1105, inconsistent target language words between the original target language sentence and the pre-processed target language sentence are searched out. That is, the inflected target language words can be searched from the target language sentence.

At Step 1110, the source language words aligned with the inconsistent target language words searched in Step 1105 can be obtained from the pre-processed source language sentence, based on the word alignment information.

Then at Step 1115, according to the inconsistent target language words and the aligned source language words and contexts of the aligned source language words in the original source language sentence, the patterns containing TLWI information can be generated.

In this embodiment, the TLWI information can include: POS of the source language word; combinations of the contexts of the source language word as conditions; inflection behavior of the target language word aligned with the source language words as action. That is, the pattern is composed of POS portion, condition portion and action portion.

Further, the combinations of the contexts of the source language word in the condition portion can be pre-determined, for example, including: a) previous source language word; b) previous source language word and next source language word; c) source language word before the previous source language word; and d) source language word after the next source language word.

For example, the Chinese sentence contains 7 Chinese words, i.e. “C₁/P₁ C₂/P₂ C₃/P₃ C₄/P₄ C₅/P₅ C₆/P₆ C₇/P₇”, wherein Cᵢ represents the Chinese word and Pᵢ represents the POS. Assuming that “C₄/P₄” is the Chinese word aligned with the inflected English word “W4/P4”, when the above example is used as the combinations of the contexts, the conditions of the extracted pattern are: a) −1 C₃; b) −1 C₃ +1 C₅; c) −2 C₂; d) +2 C₆.

Apparently, the person skilled in the art can understand that the combinations of the contexts are not limited as the above-described examples and can include other combinations.

Return to FIG. 1, after the patterns are extracted, at Step 115, the TLWI model can be trained using the patterns. Specifically, based on the type of the TLWI model, the corresponding training algorithm will be used. The training algorithm is known to the person skilled in the art and its description will be omitted.

The method for training a TLWI model based on a bilingual corpus of the embodiment will be described in detail in conjunction with a specific example.

A pair of aligned Chinese sentence and English sentence is:
Chs: [symbol] [symbol]
Eng: The girl just washed these apples.

At first, the two sentences are pre-processed as follows:

Chs: [symbol] /pron [symbol] /n [symbol] /adv [symbol] /v [symbol] /u [symbol] /pron [symbol] /nₒ /w

Eng: The/art girl/n just/adv wash/v these/pron apple/n ./w

The pre-processed Chinese sentence is shown in Table 1.

TABLE 1

| word | POS |
|---|---|
| [symbol] | pron (pronoun) |
| [symbol] | n (noun) |
| [symbol] | adv (adverb) |
| [symbol] | v (verb) |
| [symbol] | u (auxiliary word) |
| [symbol] | pron (pronoun) |
| [symbol] | n (noun) |
| _{°} | w (punctuation) |

The pre-processed English sentence is shown in Table 2.

TABLE 2

| word | POS |
|---|---|
| The | art (article) |
| girl | n (noun) |
| just | adv (adverb) |
| wash | v (verb) |
| these | pron (pronoun) |
| apple | n (noun) |
| . | w (punctuation) |

Then the word alignment is performed on the pre-processed Chinese sentence and the pre-processed English sentence to obtain the word alignment information, as shown in Table 3.

TABLE 3

| Chinese word | English word |
|---|---|
| [symbol] | The |
| [symbol] | girl |
| [symbol] | just |
| [symbol] | wash |
| [symbol] | — |
| [symbol] | these |
| [symbol] | apple |
| _{°} | . |

Then, the inconsistent English words with the original English sentence can be searched out in the pre-processed English sentence. By comparison, two inconsistent English words are obtained, i.e.

| original | pre-processed |
|---|---|
| washed | wash |
| apples | apple |

Thus, the Chinese words aligned with the two inconsistent English words in the Chinese sentence are [symbol] and

[symbol]

According to the two inconsistent English words, the aligned Chinese words and the contexts of the aligned Chinese words in the original Chinese sentence, two patterns containing the English word inflection information can be generated, as shown in Table 4.

TABLE 4

| | POS | conditions | action |
|---|---|---|---|
| P1 | v (verb) | −1 [symbol] +1 [symbol] | v + ed |
| P2 | n (noun) | −1 [symbol] | n + s |

In Table 4, the pattern P1 is generated from “wash|washed” inflection, which means that for a Chinese word with POS “v” in a Chinese sentence, if the previous Chinese word is [symbol] and the next Chinese word is [symbol] the inflection of the English word aligned with the Chinese word is to add “ed” to the termination. The pattern P2 is generated from “apple|apples” inflection, which means that for a Chinese word with POS “n” in a Chinese sentence, if the previous Chinese word is [symbol] the inflection of the English word aligned with the Chinese word is to add “s” to the termination.

Finally, after all patterns are extracted based on the bilingual example corpus, the TLWI model is trained by these patterns.

It can be seen from above description that the method for training a TLWI model based on a bilingual corpus of the embodiment can train the TLWI on the basis of the pre-processed bilingual corpus and only use the shallow parsing information. The trained TLWI model can be applied to the spoken translation system and other corpus based translation system and can improve the translation quality.

Under the same inventive concept, FIG. 3 is a TLWI method according to one embodiment of the present invention. This embodiment will be described in conjunction with the figure. For the same portions as those of the above embodiments, the description of which will be omitted properly.

The TLWI method of the embodiment can be used to further make a target language translation more accurate. In this embodiment, the target language translation is obtained by translating a source language text based on a corpus based translation model, and the source language text is pre-processed so that each of source language words in the source language text is prototypical and tagged with POS.

The corpus based translation model can be any existing or future corpus based translation model, for example, the statistical machine translation (SMT) model.

As shown in FIG. 3, at Step 301, a TLWI model is trained by using the method for training a TLWI model based on a bilingual corpus which is described in the above embodiment.

Then at Step 310, the target language words in the target language translation are inflected based on the trained TLWI model.

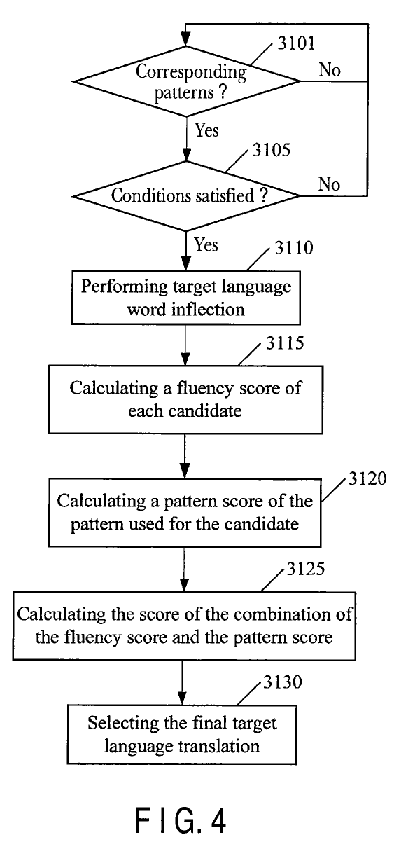

FIG. 4 shows the flow chart of the inflecting step 310. As shown in FIG. 4, firstly at Step 3101, according to the POS of each of the source language words and the TLWI model, it is determined whether there are corresponding patterns.

If there are the corresponding patterns, at Step 3105, for each of the patterns, it is verified whether the contexts of the source language word satisfy the conditions in the pattern. If the conditions in the pattern are satisfied, the action in the pattern is performed on the target language word aligned with the source language word in the target language translation. If the conditions are not satisfied, the Step 3101 is performed on the next source language word.

If it is determined in Step 3101 that there is no pattern corresponding to the source language word, the Step 3101 is performed on the next source language word.

By using above steps, the target language words to be inflected can be found in the target language translation and can be inflected.

Further, when the verification result of the Step 3105 is that the conditions in more than one patterns are satisfied, at Step 3110, the actions in the more than one patterns are performed respectively on the target language word aligned with the source language word to obtain more than one target language translation candidates.

Then at Step 3115, for each of the more than one candidates, a fluency score of the candidate is calculated based on a language model of the target language, and at Step 3120, a pattern score of the pattern used to obtain the candidate is calculated based on the TLWI model. Next at Step 3125, the fluency score and the pattern score are combined together and the score of the combination can be obtained. For example, the combination can be a product or a weighted summation. Thus the score of the combination is the score of the candidate.

Finally, at Step 3130, the candidate corresponding to the highest score is selected as final target language translation.

The steps of selecting the final target language translation from the more than one target language translation candidates can be represented by the equation in the following:

$$\hat{e} = {argmax}_{e} \{ {P}_{LM} ( e ) {f}_{TLW 1} ( e ) \}$$

where e represents the candidate, P_{LM}(•) represents the language model of the target language, f_{TLWI}(•) represents the TLWI model, argmax{•} represents a function used to select maximum value, and ê represents the final target language translation.

It can be seen from above description that the TLWI method of the embodiment can utilize the trained TLWI model to inflect the target language words in the target language translation, thus the translation quality can be improved. Further, the TLWI method can select the optimal target language word inflection from the multiple target language translation candidates by combining the language model and the TLWI model and obtain the optimal target language translation.

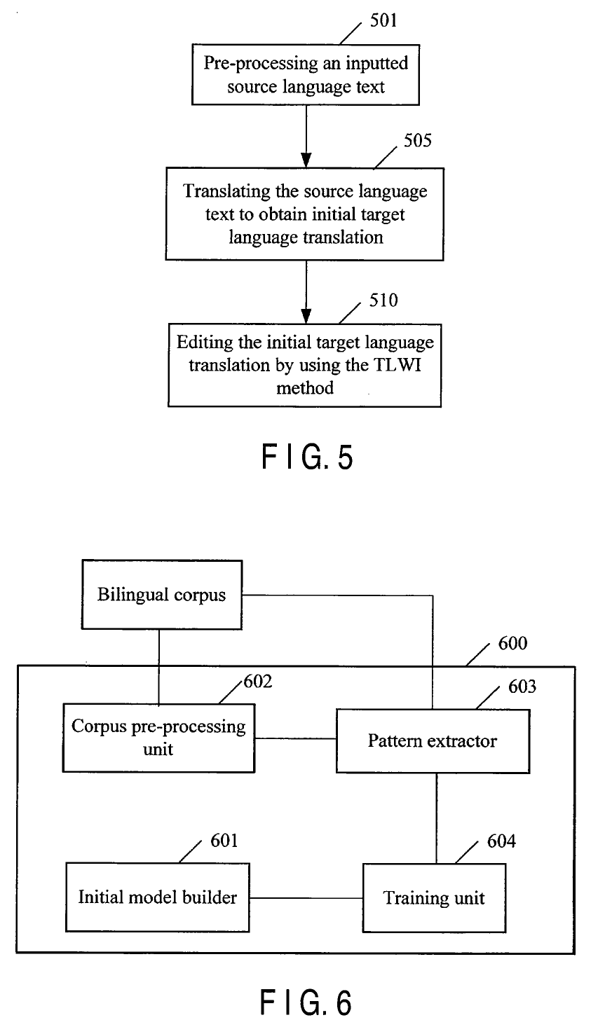

Under the same inventive concept, FIG. 5 is a flow chart of a translation method for translating a source language text into a target language translation according to one embodiment of the present invention. This embodiment will be described in conjunction with the figure. For the same portions as those of the above embodiments, the description of which will be omitted properly.

As shown in FIG. 5, firstly at Step 501, the inputted source language text is pre-processed to obtain a sequence of source language words each of which is prototypical and tagged with POS. For example, when the source language text is a Chinese sentence, at Step 501, the Chinese sentence is segmented into a sequence of Chinese words. And then each of the Chinese words is tagged with POS.

Then at Step 505, the pre-processed source language text is translated into an initial target language translation based on a corpus based translation model. As described above, the corpus based translation model can be a SMT model or the like.

Then at Step 510, the initial target language translation is edited to obtain the final target language translation by using the TLWI method described in above embodiment.

The translation method of the embodiment will be described in detail in conjunction with one example. It is assumed that the source language is Chinese and the target language is English and the corpus based translation model is the SMT model. The inputted sentence is [symbol] [symbol] Firstly the sentence is pre-processed and the pre-processed sentence is [symbol] /pron [symbol] /n [symbol] /adv [symbol] /v [symbol] /u [symbol] /nₒ /w”. Then based on the SMT model, the initial English translation is “These/pron boy/n just/adv watch/v TV/n ./w”. And the initial English translation is edited based on the TLWI model. That is, the English word “boy” is inflected into “boys” and the “watch” is inflected into “watched”. Thus the final English translation is “These boys just watched TV.”.

It can be seen from above description that the translation method for translating a source language text into a target language translation of the embodiment can make translation based on the corpus based translation model and further use the TLWI model to inflect the target language word in the target language translation, thus the translation can be more accurately.

Under the same inventive concept, FIG. 6 is a schematic block diagram of an apparatus for training a TLWI model based on a bilingual corpus according to one embodiment of the present invention. This embodiment will be described in conjunction with the figure. The TLWI model which is trained by the apparatus of this embodiment will be used in a TLWI apparatus and a translation system for translating a source language text into a target language translation which will be described later in other embodiments.

As described above, the bilingual corpus includes a plurality of aligned corpus pairs of source language and target language and the corpus can be in phrase form, sentence form or paragraph form. Commonly, the bilingual corpus is the bilingual example corpus.

As shown in FIG. 6, the apparatus 600 for training a TLWI model based on a bilingual corpus includes: an initial model builder 601, which builds an initial TLWI model; a corpus pre-processing unit 602, which pre-processes the source language corpus and the target language corpus; a pattern extractor 603, which extracts patterns containing TLWI information based on the pre-processed source language corpus and the target language corpus obtained by the corpus pre-processing unit 602; and a training unit 604, which trains the TLWI model by using the patterns obtained by the pattern extractor 603.

As described above, the TLWI model can be a probability model or a pattern recognition model or the like. The training 604 can use the corresponding training algorithm to train the TLWI model.

In the corpus pre-processing unit 602, a source language corpus pre-processing unit pre-processes the source language corpus so that each of source language words in the pre-processed source language corpus is prototypical and tagged with POS. At the same time, a target language corpus pre-processing unit pre-processes the target language corpus so that each of target language words in the pre-processed target language corpus is prototypical and tagged with POS.

For example, when the source language corpus is a Chinese sentence and the target language corpus is an English sentence, in the source language corpus pre-processing unit, firstly a segmenting unit segments the Chinese sentence into a sequence of Chinese words, and then a tagging unit tags each of the Chinese words with POS. In the target language corpus pre-processing unit, each English word in the English sentence is stemmed and tagged with POS.

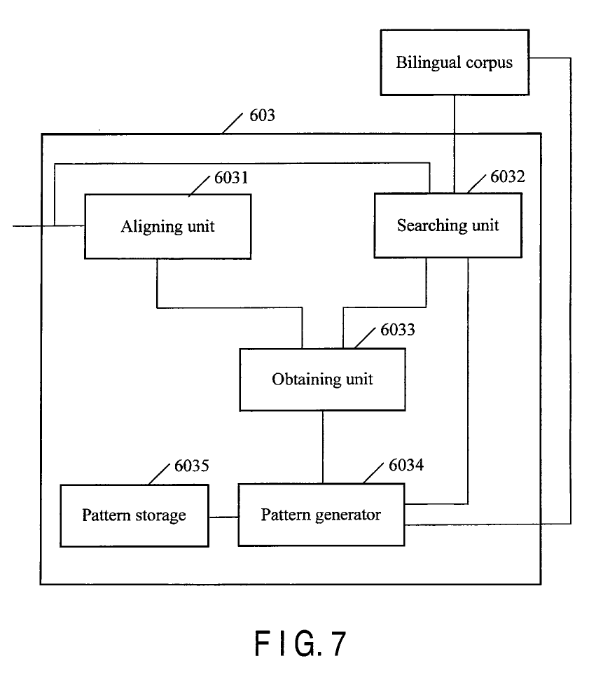

FIG. 7 shows a schematic block diagram of the pattern extractor 603. As shown in FIG. 7, the pattern extractor 603 includes: an aligning unit 6031, which aligns, for each pair of the pre-processed plurality of aligned corpus pairs of source language and target language, the source language words in the pre-processed source language corpus with the target language words in the pre-processed target language corpus to obtain word alignment information; a searching unit 6032, which searches inconsistent target language words between the original target language corpus and the pre-processed target language corpus; an obtaining unit 6033, which obtains the source language words aligned with the inconsistent target language words searched by the searching unit 6032 based on the word alignment information obtained by the aligning unit 6031; and a pattern generator 6034, which generates the patterns containing TLWI information, according to the inconsistent target language words and the aligned source language words and contexts of the aligned source language words in the original source language corpus. Thus, all patterns corresponding to each pair of the plurality of aligned corpus pairs of source language and target language can be generated. All the patterns can be stored in a pattern storage 6035 to train the TLWI model.

As described above, the TLWI information can include: POS of the source language word; combinations of the contexts of the source language word as conditions; inflection behavior of the target language word aligned with the source language words as action. The combinations of the contexts of the source language word can be pre-determined, for example, including: previous source language word; previous source language word and next source language word; source language word before the previous source language word; and source language word after the next source language word. Of course, the combinations of the contexts are not limited as the above-described examples and can include other combinations.

It should be noted that the apparatus 600 for training a TLWI model based on a bilingual corpus of this embodiment and its components can be implemented with specifically designed circuits or chips, and also can be implemented by executing corresponding programs on a general computer (processor). Also, the apparatus 600 for training a TLWI model based on a bilingual corpus in the present embodiment may operationally perform the method for training a TLWI model based on a bilingual corpus of the embodiment shown in FIGS. 1 and 2.

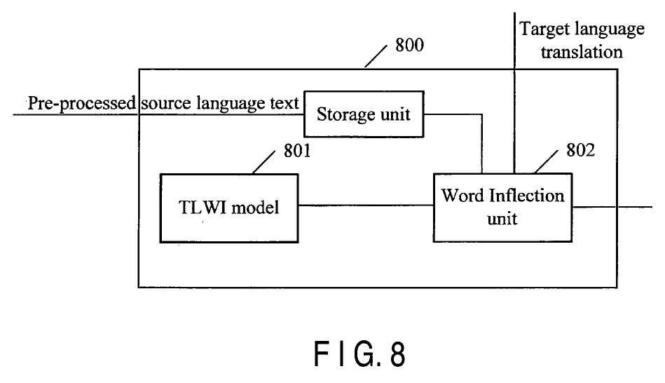

Under the same inventive concept, FIG. 8 is a schematic block diagram of a TLWI apparatus according to one embodiment of the present invention. This embodiment will be described in conjunction with the figure. For the same portions as those of the above embodiments, the description of which will be omitted properly.

In this embodiment, a source language text can be translated into the target language translation based on a corpus based translation model, and the source language text is pre-processed so that each of source language words in the source language text is prototypical and tagged with POS, and the pre-processed source language text is stored in a related storage unit.

As shown in FIG. 8, the TLWI apparatus 800 of the embodiment includes: a TLWI model 801, which is trained by the apparatus 600 for training a TLWI model based on a bilingual corpus described in above embodiment; and a word inflection unit 802, which inflect target language words in the target language translation based on the TLWI model 801.

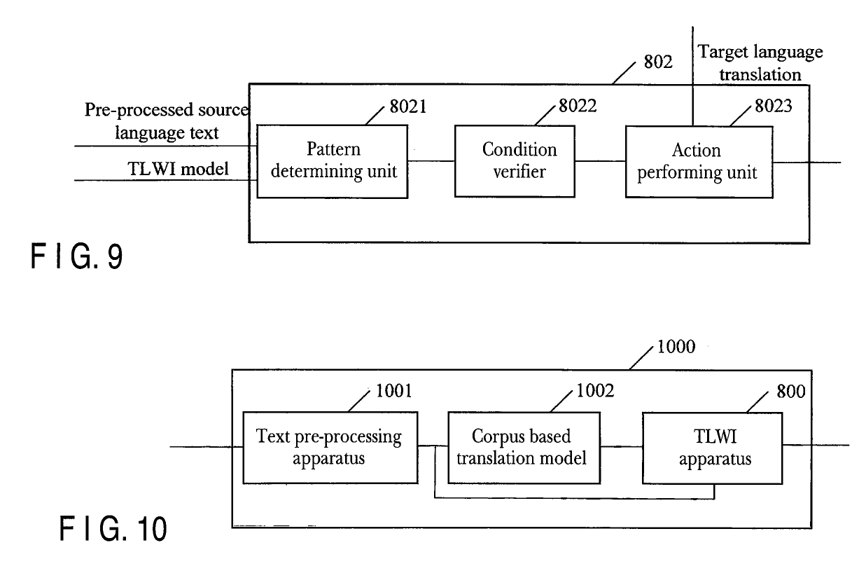

FIG. 9 shows a schematic block diagram of the word inflection unit 802. As shown in FIG. 9, when the target language words are inflected, in the word inflection unit 802, firstly a pattern determining unit 8021 determines whether there are corresponding patterns according to the POS of each of the source language words and the TLWI model 801. Then when the pattern determining unit 8021 determines that there are the corresponding patterns, a condition verifier 8022 verifies whether the contexts of the source language word satisfy the conditions in each of the patterns. Then, when the condition verifier 8022 verifies that the conditions in the pattern are satisfied, an action performing unit 8023 performs the action in the pattern on the target language word aligned with the source language word in the target language translation, thus the final target language translation can be obtained.

Further, when the verification result of the condition verifier 8022 is that the conditions in more than one patterns are satisfied, the action performing unit 8023 performs the actions in the more than one patterns respectively on the target language word aligned with the source language word to obtain more than one target language translation candidates. These target language translation candidates are stored in a storage unit. For each of the more than one candidates, in a fluency calculator, a fluency score of the candidate calculate is calculated based on a language model of the target language, and in a pattern score calculator, a pattern score of the pattern used to obtain the candidate is calculated based on the TLWI model 801. Then a combination score obtaining unit obtains a score of a combination combining the fluency score with the pattern score, as a score of the candidate. The combination can be a product or a weighted summation. Finally, a selector selects the candidate corresponding to the highest score as final target language translation.

It should be noted that the TLWI apparatus 800 of this embodiment and its components can be implemented with specifically designed circuits or chips, and also can be implemented by executing corresponding programs on a general computer (processor). Also, the TLWI apparatus 800 in the present embodiment may operationally perform the TLWI method of the embodiment shown in FIGS. 3 and 4.

Under the same inventive concept, FIG. 10 is a schematic block diagram of a translation system for translating a source language text into a target language translation according to one embodiment of the present invention. This embodiment will be described in conjunction with the figure. For the same portions as those of the above embodiments, the description of which will be omitted properly.

As shown in FIG. 10, the translation system 1000 for translating a source language text into a target language translation includes: a text pre-processing apparatus 1001, which pre-processes the inputted source language text to obtain a sequence of source language words each of which is prototypical and tagged with POS; a corpus based translation model 1002, which translates the pre-processed source language text obtained by the text pre-processing apparatus 1001 into an initial target language translation; and a TLWI apparatus, which can be the TLWI apparatus 800 described in above embodiment and can edit the initial target language translation to obtain the final target language translation.

For example, when the source language corpus is a Chinese sentence, in the text pre-processing apparatus 1001, the Chinese sentence is segmented into a sequence of Chinese words, and then each of the Chinese words with POS.

As described above, the corpus based translation model can be any existing or future corpus based translation model, such as the SMT model.

It should be noted that the translation system 1000 for translating a source language text into a target language translation of this embodiment and its components can be implemented with specifically designed circuits or chips, and also can be implemented by executing corresponding programs on a general computer (processor). Also, the translation system 1000 for translating a source language text into a target language translation in the present embodiment may operationally perform the translation method for translating a source language text into a target language translation of the embodiment shown in FIG. 5.

Although a method and apparatus for training a target language word inflection model based on a bilingual corpus, a TLWI method and apparatus, and a translation method and system for translating a source language text into a target language translation are described in detail accompanying with the concrete embodiment in the above, the present invention is not limited the above. It should be understood for persons skilled in the art that the above embodiments may be varied, replaced or modified without departing from the spirit and the scope of the present invention.

What is claimed is:

1. A method for training a target language word inflection (TLWI) model based on a bilingual corpus, wherein the bilingual corpus includes a plurality of aligned corpus pairs of source language and target language, the method comprising:
building an initial TLWI model;
pre-processing the source language corpus and the target language corpus;
extracting patterns containing TLWI information, based on the pre-processed source language corpus and the target language corpus; and
training the TLWI model by using the patterns.

2. The method for training a target language word inflection (TLWI) model based on a bilingual corpus according to claim 1, wherein the step of pre-processing the source language corpus and the target language corpus comprises:
for each pair of the plurality of aligned corpus pairs of source language and target language,
pre-processing the source language corpus so that each of source language words in the pre-processed source language corpus is prototypical and tagged with Part of Speech (POS); and
pre-processing the target language corpus so that each of target language words in the pre-processed target language corpus is prototypical and tagged with pos.

3. The method for training a target language word inflection (TLWI) model based on a bilingual corpus according to claim 1, wherein the step of extracting patterns containing TLWI information comprises:
for each pair of the pre-processed plurality of aligned corpus pairs of source language and target language,
aligning the source language words in the pre-processed source language corpus with the target language words in the pre-processed target language corpus, to obtain word alignment information;
searching inconsistent target language words between the original target language corpus and the pre-processed target language corpus;
obtaining the source language words aligned with the inconsistent target language words based on the word alignment information; and
generating the patterns according to the inconsistent target language words and the aligned source language words and contexts of the aligned source language words in the original source language corpus.

4. The method for training a target language word inflection (TLWI) model based on a bilingual corpus according to claim 1, wherein the TLWI information includes: POS of the source language word; combinations of the contexts of the source language word as conditions; inflection behavior of the target language word aligned with the source language words as action.

5. The method for training a target language word inflection (TLWI) model based on a bilingual corpus according to claim 4, wherein the combinations of the contexts includes: previous source language word; previous source language word and next source language word; source language word before the previous source language word; source language word after the next source language word.

6. The method for training a target language word inflection (TLWI) model based on a bilingual corpus according to claim 1, wherein the source language is Chinese and the target language is English.

7. The method for training a target language word inflection (TLWI) model based on a bilingual corpus according to claim 6, wherein the step of pre-processing the source language corpus comprises:
segmenting the source language corpus into a sequence of the source language words; and
tagging each of the source language words with POS.

8. The method for training a target language word inflection (TLWI) model based on a bilingual corpus according to claim 1, wherein the corpus is in at least one of sentence form, phrase form and paragraph form.

9. The method for training a target language word inflection (TLWI) model based on a bilingual corpus according to claim 1, wherein the TLWI model is a probability model.

10. The method for training a target language word inflection (TLWI) model based on a bilingual corpus according to claim 1, wherein the TLWI model is a pattern recognition model.

11. A TLWI method, wherein a source language text is translated into a target language translation and the source language text is pre-processed so that each of source language words in the source language text is prototypical and tagged with POS, the method comprising:
training a TLWI model by using a method for training a target language word inflection (TLWI) model based on a bilingual corpus according to claim 1; and
inflecting target language words in the target language translation based on the TLWI model.

12. The TLWI method according to claim 11, wherein the step of inflecting target language words in the target language translation comprises:
determining whether there are corresponding patterns according to the POS of each of the source language words and the TLWI model; and
if there are the corresponding patterns, for each of the patterns,
verifying whether the contexts of the source language word satisfy the conditions in the pattern;
if the conditions are satisfied, performing the action in the pattern on the target language word aligned with the source language word in the target language translation.

13. The TLWI method according to claim 12, wherein when the verification result of the step of verifying is that the conditions in more than one patterns are satisfied, the actions in the more than one patterns are performed respectively on the target language word aligned with the source language word to obtain more than one target language translation candidates; and
wherein the method further comprising:
for each of the more than one candidates,
calculating a fluency score of the candidate based on a language model of the target language;
calculating a pattern score of the pattern used to obtain the candidate based on the TLWI model;
obtaining a score of a combination combining the fluency score with the pattern score, as a score of the candidate;
selecting the candidate corresponding to the highest score as final target language translation.

14. A translation method for translating a source language text into a target language translation, comprising:
pre-processing the source language text to obtain a sequence of source language words each of which is prototypical and tagged with POS;
translating the pre-processed source language text into an initial target language translation based on a corpus based translation model; and
editing the initial target language translation to obtain the final target language translation by using a TLWI method according to claim 11.

15. An apparatus for training a TLWI model based on a bilingual corpus, wherein the bilingual corpus includes a plurality of aligned corpus pairs of source language and target language, the apparatus comprising:
an initial model builder configured to build an initial TLWI model;
a corpus pre-processing unit configured to pre-process the source language corpus and the target language corpus;
a pattern extractor configured to extract patterns containing TLWI information based on the pre-processed source language corpus and the target language corpus; and
a training unit configured to train the TLWI model by using the patterns.

16. The apparatus for training a TLWI model based on a bilingual corpus according to claim 15, wherein the corpus pre-processing unit comprises:
a source language corpus pre-processing unit configured to pre-process the source language corpus so that each of source language words in the pre-processed source language corpus is prototypical and tagged with POS; and
a target language corpus pre-processing unit configured to pre-process the target language corpus so that each of target language words in the pre-processed target language corpus is prototypical and tagged with POS.

17. The apparatus for training a TLWI model based on a bilingual corpus according to claim 15, wherein the pattern extractor comprises:
an aligning unit configured to, for each pair of the pre-processed plurality of aligned corpus pairs of source language and target language, align the source language words in the pre-processed source language corpus with the target language words in the pre-processed target language corpus to obtain word alignment information;
a searching unit configured to search inconsistent target language words between the original target language corpus and the pre-processed target language corpus;
an obtaining unit configured to obtain the source language words aligned with the inconsistent target language words based on the word alignment information; and
a pattern generator configured to generate the patterns according to the inconsistent target language words and the aligned source language words and contexts of the aligned source language words in the original source language corpus.

18. The apparatus for training a TLWI model based on a bilingual corpus according to claim 15, wherein the TLWI information includes: POS of the source language word; combinations of the contexts of the source language word as conditions; inflection behavior of the target language word aligned with the source language words as action.

19. The apparatus for training a TLWI model based on a bilingual corpus according to claim 18, wherein the combinations of the contexts includes: previous source language word; previous source language word and next source language word; source language word before the previous source language word; source language word after the next source language word.

20. The apparatus for training a TLWI model based on a bilingual corpus according to claim 15, wherein the source language is Chinese and the target language is English.

21. The apparatus for training a TLWI model based on a bilingual corpus according to claim 20, wherein the source language corpus pre-processing unit comprises:
a segmenting unit configured to segment the source language corpus into a sequence of the source language words; and
a tagging unit configured to tag each of the source language words with POS.

22. The apparatus for training a TLWI model based on a bilingual corpus according to claim 15, wherein the corpus is in at least one of sentence form, phrase form and paragraph form.

23. The apparatus for training a TLWI model based on a bilingual corpus according to claim 15, wherein the TLWI model is a probability model.

24. The apparatus for training a TLWI model based on a bilingual corpus according to claim 15, wherein the TLWI model is a pattern recognition model.

25. A TLWI apparatus, wherein a source language text is translated into a target language translation and the source language text is pre-processed so that each of source language words in the source language text is prototypical and tagged with POS, the apparatus comprising:
a TLWI model trained by an apparatus for training a TLWI model based on a bilingual corpus according to claim 15; and
a word inflection unit configured to inflect target language words in the target language translation based on the TLWI model.

26. The TLWI apparatus according to claim 25, wherein the word inflection unit comprises:
a pattern determining unit configured to determine whether there are corresponding patterns according to the POS of each of the source language words and the TLWI model;
a condition verifier configured to verify whether the contexts of the source language word satisfy the conditions in each of the patterns when the pattern determining unit determines that there are the corresponding patterns; and
an action performing unit configured to perform the action in the pattern on the target language word aligned with the source language word in the target language translation when the condition verifier verifies that the conditions in the pattern are satisfied.

27. The TLWI apparatus according to claim 26, wherein when the verification result of the condition verifier is that the conditions in more than one patterns are satisfied, the action performing unit performs the actions in the more than one patterns respectively on the target language word aligned with the source language word to obtain more than one target language translation candidates; and
wherein the apparatus further comprising:
a fluency calculator configured to calculate, for each of the more than one candidates, a fluency score of the candidate based on a language model of the target language;
a pattern score calculator configured to calculate a pattern score of the pattern used to obtain the candidate based on the TLWI model;
a combination score obtaining unit configured to obtain a score of a combination combining the fluency score with the pattern score, as a score of the candidate;
a selector configured to select the candidate corresponding to the highest score as final target language translation.

28. A translation system for translating a source language text into a target language translation, comprising:
a text pre-processing apparatus configured to pre-process the source language text to obtain a sequence of source language words each of which is prototypical and tagged with POS;
a corpus based translation model configured to translate the pre-processed source language text into an initial target language translation; and
a TLWI apparatus according to claim 25 configured to edit the initial target language translation to obtain the final target language translation.
